(19) United States
(12) Patent Application Publication
(10) Pub. No.: US 2016/0016334 A1
(43) Pub. Date: Jan. 21, 2016

(54) FORMING PLATE AND FIBER FABRICATION MACHINE USING THE SAME

(71) Applicant: TAIWAN GLASS IND. CORP., Taipei (TW)

(72) Inventor: Chia-Yu LIN, Taipei (TW)

(73) Assignee: TAIWAN GLASS IND. CORP., Taipei (TW)

(21) Appl. No.: 14/798,543

(22) Filed: Jul. 14, 2015

(30) Foreign Application Priority Data
Jul. 15, 2014 (TW) 103212543

(51) Int. Cl. B29C 33/00

(52) U.S. Cl. CPC B29C 33/0066; B29L 2031/757

(57) ABSTRACT

A forming plate is provided for fabricating profiled fibers. The forming plate includes plural forming units, and each of the units includes an opening, a sidewall, and at least one extension wall. The opening includes a narrow region and two wide regions. The wide regions are connected to two sides of the narrow region respectively and disconnected to each other. The sidewall surrounds the opening and extends toward a direction. The extension wall is connected to the sidewall, surrounding the wide regions, and extending toward the same direction.

### RELATED APPLICATIONS

This application claims priority to Taiwan Application Serial Number 103212543, filed Jul. 15, 2014, which is herein incorporated by reference.

### BACKGROUND

1. Field of Invention

The present invention relates to a forming plate for fabricating fibers and a fiber fabrication machine using the same. More particularly, the present invention relates to a forming plate for fabricating profiled fibers and a fiber fabrication machine using the same.

2. Description of Related Art

Generally, cross sections of ordinary fibers are similar to circles. Recently, a kind of innovative fiber having a non-circular cross section has been developed. These innovative fibers are fibers which have high profile cross sections, and are referred to as profiled fibers. Compare to normal fibers, the profiled fibers have many merits, such as high elasticity, high breathability, high reflectivity, contamination resistance, oil repellency. Also, the profiled fibers are improved on some common problems for normal fibers, such as pilling, and low opacity. However, for the reason that the molten and unsolidified fiber materials are easily affected by the surface tension and therefore tend to solidify in a circular cross section, it is not easy to form the profiled fibers.

### SUMMARY

One embodiment of the present invention provides a forming plate and a fiber fabrication machine using the same. By utilizing a special forming plate, molten fiber materials passing through the forming plate are designed to have different cooling conditions on the center and edges, a flow induced by the surface tension in the fiber materials is reduced, and thereby the profiled fibers are solidified.

According to one aspect of the present invention, the forming plate includes plural forming units, and each of the units includes an opening, a sidewall, and at least one extension wall. The opening includes a narrow region and two wide regions. The wide regions are connected to two sides of the narrow region respectively and disconnected to each other. The sidewall surrounds the opening and extends toward a direction. The extension wall is connected to the sidewall, surrounding the wide regions, and extending toward the same direction.

In one or more embodiments of the present invention, the forming plate includes a central plane perpendicular to a line interconnecting two centers of the wide regions, in which a projected length of one of the wide regions on the central plane is longer than a projected length of the narrow region on the central plane.

In one or more embodiments of the present invention, the ratio of the projected length of one of the wide regions on the central plane to the projected length of the narrow region on the central plane is in a range of about 1.3 to about 2.5.

In one or more embodiments of the present invention, the sidewall has a consistent height.

In one or more embodiments of the present invention, the sidewall includes at least one first sidewall and at least one second sidewall. The first sidewall surrounds the narrow region. The second sidewall is connected to the first sidewall and surrounds the wide regions. The extension wall is connected to the second sidewall, the narrow region and the wide regions are disposed on a basic plane, and plural projections of the extension wall and the second sidewall on the basic plane are totally overlapped.

In one or more embodiments of the present invention, the sidewall includes at least one first sidewall and at least one second sidewall. The first sidewall surrounds the narrow region. The second sidewall is connected to the first sidewall and surrounds the wide regions. The extension wall is connected to the second sidewall, the narrow region and the wide regions are disposed on a basic plane, and plural projections of the extension wall and the second sidewall on the basic plane are partially overlapped.

In one or more embodiments of the present invention, the narrow region and the wide regions are disposed on a basic plane, and the ratio of a projected length of the narrow region on the basic plane to a projected length of one of the wide regions on the basic plane is in a range of about 1.5 to about 3.

In one or more embodiments of the present invention, the wide regions are plural cylindrical spaces, and the narrow region is a cuboid space.

In one or more embodiments of the present invention, the extension wall and the sidewall are made of different materials.

According to one aspect of the present invention, a fiber fabrication machine includes the aforementioned forming plate, a gathering device, and a cooling device. The gathering device collects plural fibers passing through the forming plate. The cooling device is disposed between the forming plate and the gathering device.

In one or more embodiments of the present invention, the fiber fabrication machine includes an air delivery device disposed between the forming plate and the cooling device for delivering air between the forming plate and the cooling device.

In one or more embodiments of the present invention, the air delivery device delivers air at a gas pressure from 0.01 to 0.04 kilograms per square millimeter in cross section and at a gas temperature from 18 to 25 degrees on the Celsius scale.

In one or more embodiments of the present invention, the gathering device coils the fibers at a rate of 1800 to 2200 meters per minute. The length of the forming unit is about 2 millimeters. The fibers produced by the fiber fabrication machine have a fiber shape factor greater than about 70%.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a top view of a forming plate according to one embodiment of this invention;

FIG. 2 is a stereoscopic diagram of a forming unit of the forming plate of FIG. 1;

FIG. 3 is a top view of the forming unit of FIG. 2;

FIG. 4 is a side view of the forming unit of FIG. 2;

FIG. 5 is a stereoscopic diagram of a forming unit according to another embodiment of this invention;

FIG. 6 is a stereoscopic diagram of a forming unit according to another embodiment of this invention;

FIG. 7 is a stereoscopic diagram of a forming unit according to another embodiment of this invention; and

FIG. 8 is a schematic view of a fiber fabrication machine according to one embodiment of this invention.

### DETAILED DESCRIPTION

The following embodiments are disclosed with accompanying diagrams for detailed description. For illustration clarity, many details of practice are explained in the following descriptions. However, it should be understood that these details of practice do not intend to limit the present invention. That is, these details of practice are not necessary in parts of embodiments of the present invention. Furthermore, for simplifying the drawings, some of the conventional structures and elements are shown with schematic illustrations.

As used herein, “around”, “about” or “approximately” shall generally mean within 20 percent, preferably within 10 percent, and more preferably within 5 percent of a given value or range. Numerical quantities given herein are approximate, meaning that the term “around”, “about” or “approximately” can be inferred if not expressly stated.

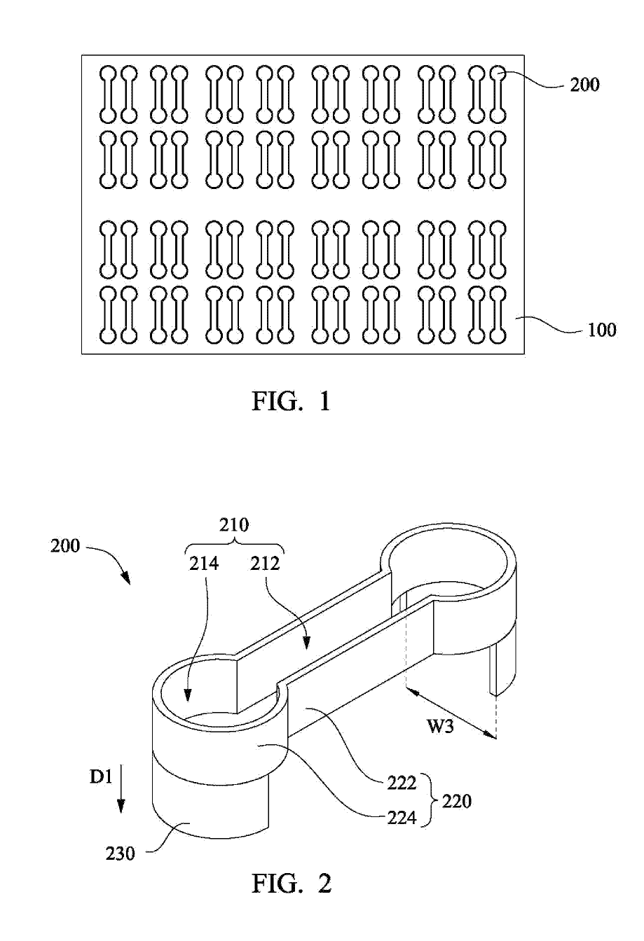

Reference is made to both FIG. 1 and FIG. 2. FIG. 1 is a top view of a forming plate 100 according to one embodiment of this invention. FIG. 2 is a stereoscopic diagram of a forming unit 200 of the forming plate 100 of FIG. 1. According to one aspect of the present invention, the forming plate 100 includes plural forming units 200, and the forming unit 200 can be arranged in an array. Each of the forming units 200 includes an opening 210, a sidewall 220, and at least one extension wall 230. The opening 210 includes a narrow region 212 and two wide regions 214. Herein, the wide regions 214 can be cylindrical spaces, and the narrow region 212 can be a cuboid space. The wide regions 214 are connected to two edges of the narrow region 212 respectively and disconnected to each other. The sidewall 220 surrounds the opening 210 and extends toward a direction D1. The extension wall 230 is connected to the sidewall 220, surrounding the wide regions 214, and extending toward the same direction D1.

In one or more embodiments, the height of the sidewall 220 remains consistent. The sidewall 220 includes a first sidewall 222 and a second sidewall 224. The first sidewall 222 surrounds the narrow region 212. The second sidewall 224 is connected to the first sidewall 222 and surrounds the wide regions 214, and the extension wall 230 is connected to the second sidewall 224.

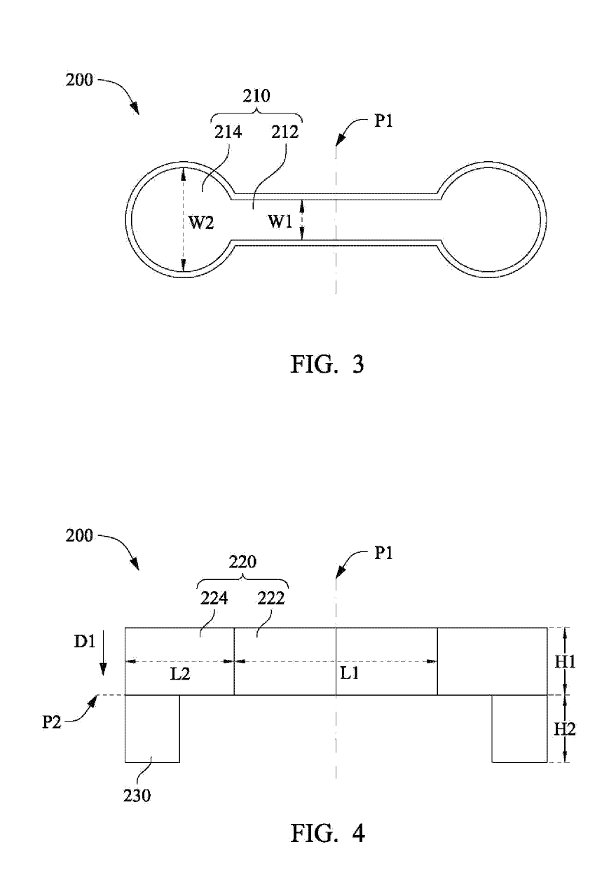

FIG. 3 is a top view of the forming unit 200 of FIG. 2. For better illustrating, herein each of the forming units 200 is configured to include a central plane P1. The central plane P1 is perpendicular to a line interconnecting two centers of the wide regions 214, and a vertical distance between the central plane P1 and a center of one of the wide regions 214 is substantially the same as a vertical distance between the central plane P1 and a center of another of the wide regions 214. The narrow region 212 and the wide regions 214 can be projected onto the central plane P1 respectively, in which a projected length of one of the wide regions 214 on the central plane P1 is referred to as a wide region width W2, and a projected length of the narrow region 212 on the central plane P1 is referred to as a narrow region width W1.

In one or more embodiments, the wide region width W2 is larger than the narrow region width W1. That is, a middle of the opening 210 is narrower than two edges of the opening 210. Ideally, the ratio of the projected length of one of the wide regions 214 on the central plane P1 (which is the wide region width W2) to the projected length of the narrow region 212 on the central plane P1 (which is the narrow region width W1) is in a range of 1.3 to 2.5. That is, the wide region width W2 is substantially the result of multiplying the narrow region width W1 by the range of 1.3 to 2.5. Herein, though the two wide regions 214 are depicted as the same shape and the wide region widths W2 are the same, it should not limit the scope of the present invention. The wide regions 214 can have different shapes, and the wide region widths W2 can be different.

Reference is made to both FIG. 2 and FIG. 3. In one or more embodiments, a projected length of the extension wall 230 on the central plane P1 is referred to as an extending width W3. The extending width W3 is the same as the wide region width W2. That is, the extension wall 230 is connected to the widest portion of the second sidewall 224.

Reference is made to both FIG. 2 and FIG. 4. FIG. 4 is a side view of the forming unit 200 of FIG. 2. For better illustrating, the forming unit 200 is configured to include a basic plane P2 perpendicular to the central plane P1. The narrow region 212 and the wide regions 214 are disposed on the basic plane P2. That is, the first sidewall 222 and the second sidewall 224 are both disposed on the basic plane P2, and the extension wall 230 and the sidewall 220 are disposed on two opposite sides of the basic plane P2.

In one or more embodiments, projections of the extension wall 230 and the second sidewall 224 on the basic plane P2 partially overlap. In other words, the extension wall 230 is partially connected to the second sidewall 224, and the extension wall 230 extends toward the same direction D1 as the second sidewall 224 does. The projected shape of the second sidewall 224 on the basic plane P2 approximates to an arc of a circle, and the projected shape of the extension sidewall 230 on the basic plane P2 approximates to an arc of a semi-circle.

In one or more embodiments of the present invention, the first sidewall 222 and the second sidewall 224 are both disposed on the basic plane P2. The thickness of the sidewall 220 is neglected herein. For better illustrating, the projected length of the first sidewall 222 on the basic plane P2 is referred to as a narrow region length L1, and the projected length of the second sidewall 224 on the basic plane P2 is referred to as a wide region length L2. In one or more embodiments, the ratio of the narrow region length L1 to the wide region length L2 is in a range of 1.5 to 3. That is, the narrow region length L1 is the result of multiplying the wide region length L2 by a range of 1.5 to 3. In this way, the ratio of a sum of the narrow region length L1 and the two wide region lengths L2 to the wide region width W2 is in a range of 3.5 to 5. That is, the aspect ratio of the forming unit 200 is substantially in the range of 3.5 to 5.

Furthermore, in one or more embodiments of the present invention, the sidewall 220 has a sidewall height H1, and the extension wall 230 has an extending height H2. The sidewall height H1 has the same value as the extending height H2, but it should not limit the scope of the present invention. The extending height H2 can be a result of multiplying the sidewall height H1 by the ranges of 0.5 to 0.8, 0.9 to 1.2, or 1.2 to 1.5.

In addition, in one or more embodiments of the present invention, the extension wall 230 and the sidewall 220 can be made of the same material, which can be one of the heat-resistant metal materials, such as gold-platinum alloys, tantalums, stainless steels, etc. In one or more embodiments of the present invention, the extension wall 230 and the sidewall 220 can be made of the different materials. For example, the extension wall 230 can be made of gold-platinum alloy with a determined ratio, and the sidewall 220 can be made of gold-platinum alloy with another determined ratio.

In one or more embodiments of the present invention, the forming plate 100 is utilized to form profiled fibers. In use, the forming plate 100 bears the molten fiber materials. Affected by the gravity and the pulling of the solidified fibers, the molten fiber materials pass through the opening of the forming unit 200 and then leave the forming plate 100. Then, exposing to the cold gas, the molten fiber materials are fast cooled to solidify. During the fast cooling process, affected by the environmental temperature, the gravity, the surface tension, the surface properties of the solidified fibers, and the adhesion force on the sidewall 220 and the extension wall 230, the shape of the molten fiber materials is changed and has an influence on the final shape of the solidified fibers. Herein, the molten fiber materials refer to the unsolidified fiber materials in liquid form. The forming plate 100 keeps the temperature of molten fiber materials in a range of 900 to 1500 degrees on the Celsius scale.

In the process of making the molten fiber materials pass through the opening of the forming unit 200 of the forming plate 100, the narrow region 212 and the wide regions 214 are filled with the molten fiber materials at the beginning. Since the wide region width W2 is configured to be larger than the narrow region width W1, it is easy to distribute a large amount of the molten fiber materials at the two sides (the wide regions 214) of the forming unit 200, and a small amount of the molten fiber materials is distributed at the center (the narrow region 212) of the forming unit 200. When the molten fiber materials slide down and leave the sidewall 220 as a result of the gravity and the pulling of the solidified fibers, the molten fiber materials at the center leave the first sidewall 222 of the forming unit 200, and are then exposed to the cold gas. At the same time, the molten fiber materials at the two sides leave the second sidewall 224, but due to the adhesion force on the extension wall 230, leave the forming unit 200 late, and therefore the molten fiber materials at the two sides are exposed to the cold gas at a later interval.

Herein, the extension wall 230 offers an effect of heat preservation for the molten fiber materials. Therefore, after the molten fiber materials leave the sidewall 220 having a high temperature, due to the effect of the heat preservation offered by the extension wall 230, the molten fiber materials fail to be fast-cooled by the exposure to the cold gas, and the viscosity of the molten fiber materials is prevented from decreasing greatly.

In other words, owing to the fact that the molten fiber materials at the center are easily affected by the environmental temperature due to the small amount, and the fact that the molten fiber materials at the two sides are heat-preserved by the extension wall 230, the molten fiber materials at the center have a lower temperature and tend to solidify fast, and the molten fiber materials at the two sides have a higher temperature and tend to solidify slow.

The molten fiber materials at the center have a lower temperature and a slow flow rate, and the molten fiber materials at the two sides have a higher temperature and a fast flow rate. By appropriately controlling the narrow region width W1 and the narrow region length L1, which is related to the distribution region of the molten fiber materials having the slow flow rate, it can be prevented that the molten fiber materials at the two sides move towards the center and recovered to establish a circular cross section due to the surface tension. Therefore, the profiled fiber having a non-circular cross section can be provided.

For example, reducing the narrow region width W1 can make the molten fiber materials at the center be easily cooled down by the environment, and therefore solidify early. By enlarging the narrow region length L1, the change of the appearance of the molten fiber materials can be buffered since the change is controlled by the flow from the two sides towards the center, in which the flow is induced by the surface tension. The molten fiber materials can solidify at the time when the change of the appearance is small. The narrow region width W1 and the narrow region length L1 can be tuned correspondingly based on the wide region width W2 and the wide region length L2, as in the aforementioned numerical ranges. However, there are many factors in the operation process, and the numerical ranges should not limit the scope of the present invention.

In one or more embodiments, according to the environmental conditions, the coverage of the extension wall 230 can be changed. For example, the extension wall 230 can be partially connected to the second sidewall 224, or totally connected to the second sidewall 224.

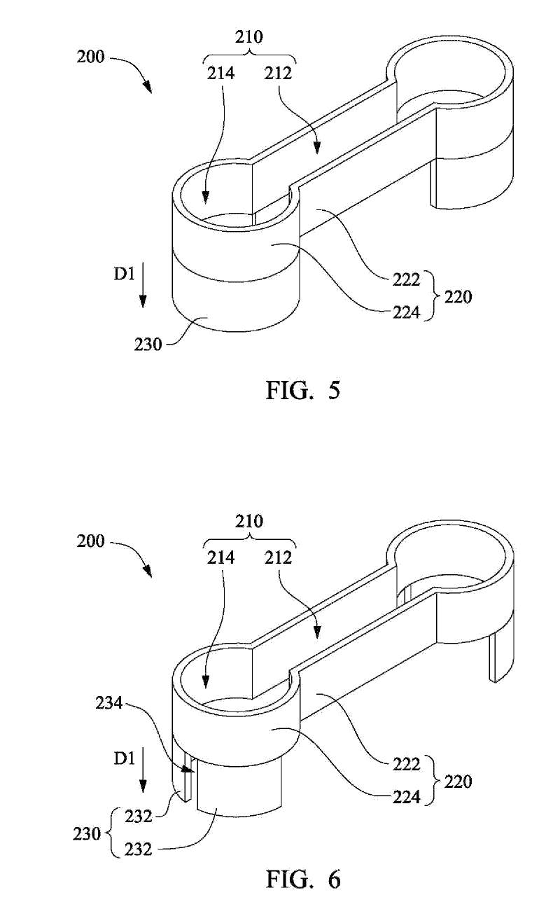

FIG. 5 is a stereoscopic diagram of a forming unit 200 according to another embodiment of this invention. This embodiment is similar to the embodiment of FIG. 1. The difference is that, in this embodiment, the projections of the extension wall 230 and the second sidewall 224 on the basic plane P2 (referring to FIG. 4) are totally overlapped. In other words, the extension wall 230 is totally connected to the second sidewall 224, and the extension wall 230 and the second sidewall 224 extend along the same direction D1 and therefore has the same projected shape. The configuration can enhance the ratio of the amount of the molten fiber materials at the two sides to the amount of the total molten fiber materials, raise the temperature of the molten fiber materials at the two sides, and change the relative flow rate of the molten fiber materials.

FIG. 6 is a stereoscopic diagram of a forming unit 200 according to another embodiment of this invention. This embodiment is similar to the embodiment of FIG. 1. The difference is that, in this embodiment, the extension wall 230 is separated into plural sub-extension walls 232, and there are plural spaces 234 between the sub-extension walls 232, so that the sub-extension walls 232 are disconnected. In other words, the sub-extension walls 232 are connected to the second sidewall 224, and the spaces 234 are disposed therebetween. The existence of the spaces 234 can change the temperature of the molten fiber materials at the two sides, adjust the cooling rate, temperature, flow rate, etc. of the molten fiber materials at the two sides. Therefore, the molten fiber materials at the center and a portion of the molten fiber materials at the two sides can solidify early.

In one or more embodiments, the wide regions 214 are cylindrical spaces, and the narrow region 212 is a cuboid space, but the exemplary structures herein should not limit the scope of the present invention. The narrow region 212 and the wide regions 214 of the forming units 200 are not limited to the aforementioned structures. The wide regions 214 can be cuboid spaces, and the narrow region 212 can be elliptic cylindrical space or other cuboid space. The narrow region 212 and the wide regions 214 of the forming units 200 can also be any structures satisfying that the narrow region width W1 is less than the wide region width W2.

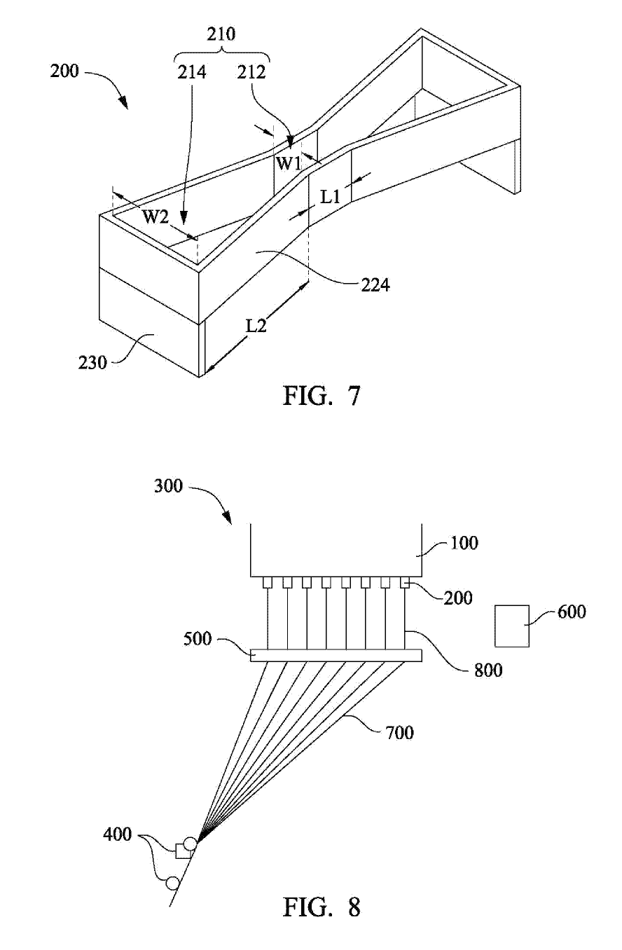

FIG. 7 is a stereoscopic diagram of a forming unit 200 according to another embodiment of this invention. This embodiment is similar to the embodiment of FIG. 1. The difference is that, in this embodiment the wide regions 214 are not cylindrical spaces but trapezoidal cylindrical spaces. In addition, the aforementioned ratio of the wide region width W2 to the narrow region width W1 and the aforementioned ratio of the narrow region length L1 to the wide region length L2 can be tuned according to the design requirements in real situation.

In this embodiment, the extension wall 230 is two parallel flat surfaces. Similarly, the wide region width W2 of the wide region 214 is larger than the narrow region width W1 of the narrow region 212. Also, the extension wall 230 is connected to the widest portion of the second sidewall 224. Compare to the embodiment of FIG. 1, the extension wall 230 of this embodiment has less contact area with the molten fiber materials, and the narrow region length L1 is smaller than the wide region length L2.

FIG. 8 is a schematic view of a fiber fabrication machine 300 according to one embodiment of this invention. According to one aspect of the present invention, the fiber fabrication machine 300 includes the aforementioned forming plate 100, a gathering device 400, and a cooling device 500. The forming plate 100 includes the plural forming units 200. The gathering device 400 is used to collect plural solidified fibers 700. The cooling device 500 is disposed between the forming plate 100 and the gathering device 400 for cooling the unsolidified molten fibers 800.

In one or more embodiments, the gathering device 400 coils the fibers 700 at a rate of ranges of 700 meters to 800 meters, 1800 meters to 2100 meters, or 1900 meters to 2200 meters per minute. The cooling device 500 can perform the cooling process with chilled water in normal temperature range of 23 to 26 degrees on Celsius scale.

In one or more embodiments of the present invention, the fiber fabrication machine 300 includes an air delivery device 600 disposed between the forming plate 100 and the cooling device 500 for delivering air between the forming plate 100 and the cooling device 500. The air delivery device 600 can deliver air in opposite directions. The air delivery device 600 can deliver air at a gas pressure range of 0.01 to 0.04 kilograms per square millimeter in cross section and at a gas temperature range of 19 to 29 degrees on the Celsius scale. The gas pressure of the air delivery device 600 can be controlled not to destroy the unsolidified molten fibers 800. For example, the air delivery device 600 deliver air at gas pressure ranges of 0.01 to 0.02, 0.2 to 0.03, or 0.03 to 0.04 kilograms per square millimeter in cross section and at a gas temperature range of 18 to 29 degrees on the Celsius scale. The gas temperature range is preferably from 18 to 25 degrees on the Celsius scale.

In the operation of the fiber fabrication machine 300, the forming plate 100 bears the molten fiber 800. Affected by the weight and the pulling of the solidified fibers 700, the molten fibers 800 pass through the forming unit 200 and then leave the forming plate 100. The tread-like molten fibers 800 are formed.

The molten fibers 800 can have a good fiber shape factor at the beginning, but lately, due to the surface tension of the molten fibers 800, the molten fibers 800 away from the forming plate 100 are deformed, and the fiber shape factor are reduced gradually. Meanwhile, the molten fibers 800 are fast-cooled by the cold gas delivered by the air delivery device 600 and the cooling device 500, the deformation rate of the molten fibers 800 are reduced, and therefore the molten fibers 800 can be cooled and solidified to form the fibers 700 when the fiber shape factor is still high. Herein, the fiber shape factor is equivalent to (1−inradius of a pattern of the cross section of the profiled fiber/circumradius of a pattern of the cross section of the profiled fiber)×100%. The higher the fiber shape factor, the more complex the pattern of the cross section.

In one or more embodiments of the present invention, the profiled fibers can be obtained by tuning plural factors, such as the temperature of the molten fibers, the ratio of the narrow region length L1 (referring to FIG. 4) to the wide region length L2 (referring to FIG. 4) of the forming unit 200, the coiling rate of the gathering device 400, the temperature and gas pressure of the air delivered by the air delivery device 600, etc. The following is one of plural experimental results.

The temperature of the molten fibers 800 is configured to be in a range of 1100 to 1140 degrees on Celsius scale. The ratio of the narrow region length L1 to the wide region length L2 of the forming unit 200 is in a range of 2 to 2.5. The ratio of wide region width W2 to narrow region width W1 is about 1.5. The gathering device 400 coils the fibers 700 at a rate of 1800 to 2200 meters per minute. The air delivery device 600 delivers air at a temperature of 19 to 23 degrees on Celsius scale and at a gas pressure from 0.01 to 0.04 kilograms per square millimeter in cross section. The length of the forming unit is about 2 millimeters. The molten fibers 800 are fabricated at a rate of 20 to 30 kilograms per hour by the forming unit. As a result, the fibers 700 are formed to have a ratio of the length to the width in a range of about 3 to about 4, and a fiber shape factor greater than about 70%. The fiber shape factor is preferably in a range of 85% to 95%.

In comparison, if the air delivery device 600 is removed, the remaining configuration can produce fibers 700 having a ratio of the length to the width in a range of about 2 to about 3 and a fiber shape factor in a range of 40% to 60%. Therefore, it is clear that the air delivery device 600 can help the molten fibers 800 to be cooled and solidified, and therefore enhances the fiber shape factor of the fibers 700.

One embodiment of the present invention provides a forming plate and a fiber fabrication machine. By utilizing a special forming plate, molten fiber materials passing through the forming plate are designed to have different cooling conditions on the center and edges, and thereby the molten fibers having a high profiled cross section is produced. Furthermore, by the fast cooling process of the air delivery device, the molten fibers can be cooled down and solidified. Therefore the profiled fibers are formed.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A forming plate for fabricating a plurality of profiled fibers, wherein the forming plate comprises a plurality of forming units, each of the forming units comprises:
an opening comprising:
a narrow region; and
two wide regions connected to two edges of the narrow region respectively and disconnected to each other;
a sidewall surrounding the opening and extending toward a direction; and
at least one extension wall connected to the sidewall, surrounding the wide regions, and extending toward the same direction.

2. The forming plate of claim 1, further comprising a central plane perpendicular to a line interconnecting two centers of the wide regions, wherein a projected length of one of the wide regions on the central plane is longer than a projected length of the narrow region on the central plane.

3. The forming plate of claim 2, wherein the ratio of the projected length of one of the wide regions on the central plane to the projected length of the narrow region on the central plane is in a range of about 1.3 to about 2.5.

4. The forming plate of claim 1, wherein the sidewall has a consistent height.

5. The forming plate of claim 1, wherein the sidewall comprises:
at least one first sidewall surrounding the narrow region; and
at least one second sidewall connected to the first sidewall and surrounding the wide regions, wherein the extension wall is connected to the second sidewall, the narrow region and the wide regions are disposed on a basic plane, and a plurality projections of the extension wall and the second sidewall on the basic plane are totally overlapped.

6. The forming plate of claim 1, wherein the sidewall comprises:
at least one first sidewall surrounding the narrow region; and
at least one second sidewall connected to the first sidewall and surrounding the wide regions, wherein the extension wall is connected to the second sidewall, the narrow region and the wide regions are disposed on a basic plane, and a plurality projections of the extension wall and the second sidewall on the basic plane are partially overlapped.

7. The forming plate of claim 1, wherein the narrow region and the wide regions are disposed on a basic plane, and the ratio of a projected length of the narrow region on the basic plane to a projected length of one of the wide regions on the basic plane is in a range of about 1.5 to about 3.

8. The forming plate of claim 1, wherein the wide regions are a plurality of cylindrical spaces, and the narrow region is a cuboid space.

9. The forming plate of claim 1, wherein the extension wall and the sidewall are made of different materials.
